(19) United States
(12) Patent Application Publication
(10) Pub. No.: US 2020/0189442 A1
(43) Pub. Date: Jun. 18, 2020

(54) Self-Propelled Vessel Assembly

(71) Applicant: Chad Daloia, Washington, PA (US)

(72) Inventor: Chad Daloia, Washington, PA (US)

(21) Appl. No.: 16/713,043

(22) Filed: Dec. 13, 2019

Related U.S. Application Data
(60) Provisional application No. 62/781,016, filed on Dec. 18, 2018.

(51) Int. Cl. B60P 3/22; F04B 17/06; F04B 23/02

(52) U.S. Cl. CPC B60P 3/225; F04B 23/02; F04B 17/06; B60P 3/2215

(57) ABSTRACT

The present invention relates to a self-propelled vessel assembly (3) that includes a self-propelled vehicle (11) that includes an open-box bed (14). The self-propelled vessel assembly (3) further includes, a vessel (50) that is reversibly received (and reversibly resides) within the open-box bed (14) of the self-propelled vehicle (11). The self-propelled vessel assembly (3) additionally includes, a pump assembly (59) that includes at least one pump (62) and at least one conduit (e.g., 71) that is in fluid communication with the interior volume (56) of the vessel (50). The pump assembly (59) resides on a support structure (47) that is reversibly attached to the self-propelled vehicle (11).

### CROSS REFERENCE TO RELATED APPLICATION

The present application is entitled to and claims priority to U.S. Provisional Patent Application No. 62/781,016, filed on Dec. 18, 2018, the disclosure of which is incorporated herein by reference in its entirety.

### FIELD

The present invention relates to a self-propelled vessel assembly that includes a self-propelled vehicle that includes an open-box bed, a vessel that is reversibly received within the open-box bed of the self-propelled vehicle, and a pump assembly that includes at least one pump and at least one conduit that is in fluid communication with the interior volume of the vessel, in which the pump assembly resides on a support structure that is reversibly attached to the self-propelled vehicle.

### BACKGROUND

Fluid transport vehicles, such as, fluid trucks or fluid tankers, such as, water trucks/tankers, are typically used for transporting fluids, such as water, to and from various sites. The tank of the fluid truck is typically and in effect permanently fixed to the chassis of the truck. With the tank permanently fixed to the truck, the volume of the tank and the tank itself cannot be easily changed. For example, a fluid truck that transports waste water cannot be easily modified for purposes of transporting potable water.

It would be desirable to develop new fluid transport vehicles that provide more flexible options with regard to at least modifying and/or interchanging the fluid tank thereof.

### SUMMARY

In accordance with the present invention, there is provided a self-propelled vessel assembly comprising:

(a) a self-propelled vehicle comprising:
an open-box bed comprising a first sidewall, a second side-wall, a forward wall, optionally a tailgate, and a floor, that together define a box volume and an open end, wherein said first sidewall and said second sidewall are opposed to each other, and said optional tailgate and said forward wall are opposed to each other; and
(b) a vessel that is reversibly received within said box volume, said vessel having an interior volume; and
(c) a pump assembly comprising at least one pump positioned on a support structure that is reversibly attached to said self-propelled vehicle, said pump assembly comprising at least one conduit that is in fluid communication with said pump and said interior volume of said vessel.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### BRIEF DESCRIPTION OF THE DRAWINGS

FIG. 1 is a perspective exploded view of a self-propelled vessel assembly according to the present invention;

FIG. 2 is a schematic representation of a pump assembly according to the present invention that includes a single pump; and

FIG. 3 is a schematic representation of a pump assembly according to the present invention that includes two separate pumps.

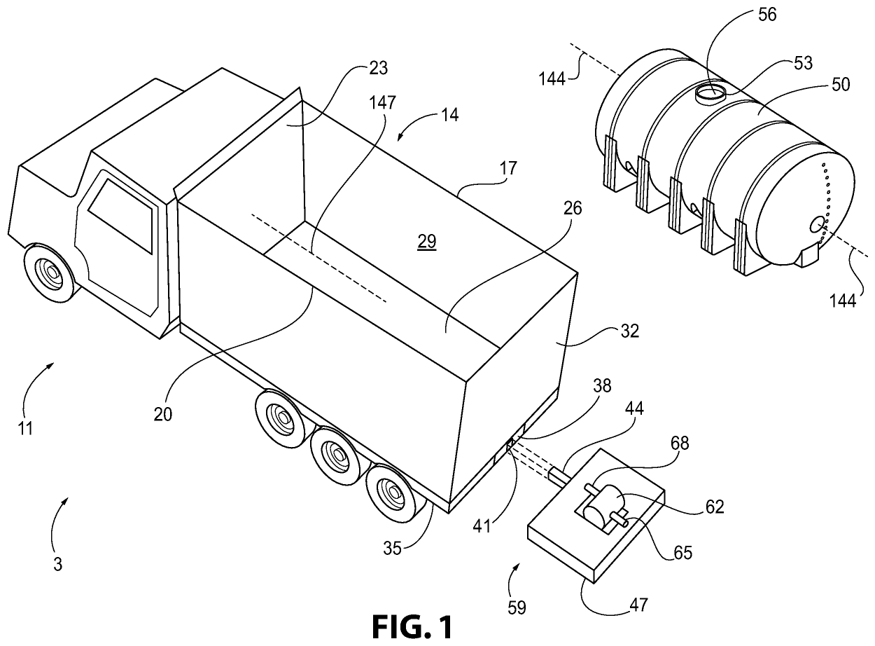

In FIGS. 1-3 like characters refer to the same components and/or elements, as the case may be, unless otherwise stated.

### DETAILED DESCRIPTION

As used herein, the articles “a,” “an,” and “the” include plural referents unless otherwise expressly and unequivocally limited to one referent.

Unless otherwise indicated, all ranges or ratios disclosed herein are to be understood to encompass any and all subranges or subratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as, but, not limited to, 1 to 6.1, 3.5 to 7.8, and 5.5 to 10.

Unless otherwise indicated, all numbers expressing dimensions, volumes, and so forth used in the specification and claims are to be understood as modified in all instances by the term “about.”

As used herein, spatial or directional terms, such as, “left”, “right”, “inner”, “outer”, “above”, “below”, and the like, relate to the invention as it is depicted in the drawing figures. It is to be understood, however, that the invention can assume various alternative orientations and, accordingly, such terms are not to be considered as limiting.

All documents, such as, but, not limited to, issued patents and patent applications, referred to herein, and unless otherwise indicated, are to be considered to be “incorporated by reference” in their entirety.

As used herein, the term “hydrofracture” relates to hydraulic fracturing. As used herein the term “hydrofracture wastewater” means wastewater that results from hydraulic fracturing processes. As used herein, the term “hydrofracture flowback water” means flowback water that results from hydraulic fracturing processes. As used herein, the term “hydrofracture production (or produced) water” means production (or produced) water that results from hydraulic fracturing processes.

As used herein, the term “lotic water” means flowing surface water, including, but not limited to, spring water, stream water, and/or river water.

As used herein, the term “open-box bed” means the top of the open-box bed, which is opposed to the floor thereof, is open (or an open top). With some embodiments, the open top of the open-box bed is reversibly covered by a reversibly removable cover, such as a tarp.

With reference to FIG. 1 of the drawings, there is depicted a self-propelled vessel (3) according to the present invention that includes a self-propelled vehicle (11). The self-propelled vehicle (11) includes an open-box bed (14) that includes a first sidewall (17), a second side-wall (20), a forward wall (23), an optional tailgate (32), and a floor (26), that together define a box volume (29). The first sidewall (17) and the second sidewall (20) are opposed to each other. The optional tailgate (32) and the forward wall (23) are opposed to each other.

With some embodiments, the tailgate (32) is not present, in which case the open-box bed (14) includes an open end that is opposed to the forward wall (23). The open end of the open-box bed (14) is, with some embodiments, defined by first sidewall (17), second side-wall (20) and floor (26). The open end of the open-box bed (14), with some embodiments, is indicated by character (32).

The self-propelled vehicle (11), with some embodiments, includes a chassis (35) that optionally includes a hitch (38). The hitch (38) can be permanently or reversibly mounted to the chassis (35). The hitch can be selected from art-recognized hitches including, but not limited to, fixed tongue hitches and receiver hitches. Hitch (38) of FIG. 1 as depicted is a receiver hitch that includes a receptacle (41) that is dimensioned to receive reversibly therein a tongue or drawbar (44) of support structure (47).

The self-propelled vessel assembly (3) further includes a vessel (50) that is dimensioned so as to be reversibly received within the box volume (29) of the open-box bed (14). The vessel (50) includes at least one opening (53) that is in fluid communication with the interior volume (or interior) (56) of the vessel (50).

The self-propelled vessel assembly (3) further includes a pump assembly (59) that includes at least one pump (62) that is positioned (or resides) on a support structure (47). Support structure (47) is reversibly attached to the self-propelled vehicle (11).

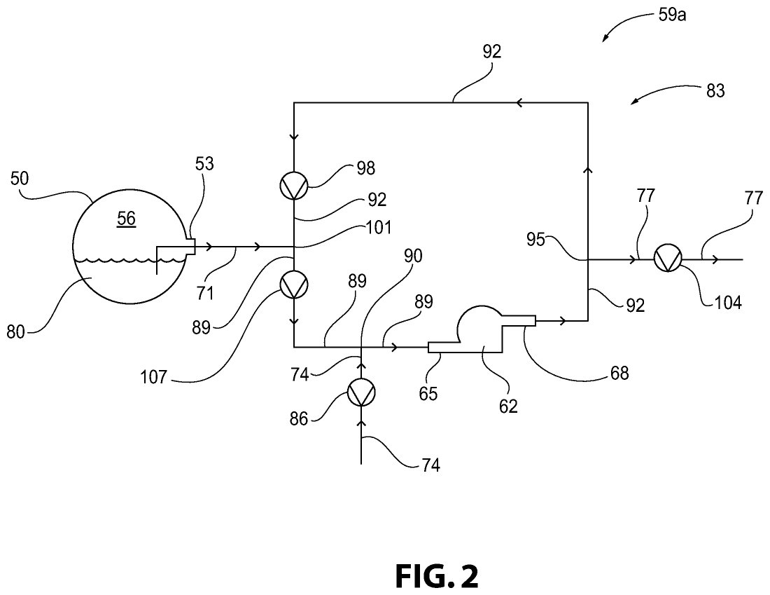

With some embodiments, support structure (47) is reversibly attached to the optional hitch (38) of the chassis (35) of the self-propelled vehicle (11). As discussed above, and as depicted FIG. 1, hitch (38) is a receiver hitch that includes a receptacle (41) that is dimensioned to reversibly receive a tongue or drawbar (44) that is attached to support structure (47). Tongue (44) can be reversibly secured within receptacle (41) of hitch (38) in accordance with art-recognized methods, such as, but not limited to, one or more pins (not shown) that extend laterally through the housing (not shown) of receptacle (41) and tongue (44), in which the pin is secured by a hitch pin (not shown). The pump (62) includes at least one inlet (65) and at least one outlet (68). The pump assembly includes at least one conduit (such as, conduit 71 of FIG. 2) that is in (or provides) fluid communication between pump (62) and the interior volume (56) of the vessel (50).

With some further embodiments, the support structure (47) is reversibly attached to the tailgate (32), such as, by one or more upwardly extending hooks (not shown) each including a lower portion that is attached to the support structure (47) and an upper hook portion that extends over the top of the tailgate (32).

With some embodiments of the present invention, the self-propelled vehicle is a dump truck. With some additional embodiments, the self-propelled vehicle is a triaxle dump truck, such as, depicted in FIG. 1 with reference to self-propelled vehicle (11).

With some embodiments of the present invention, the pump assembly includes a single pump, such as, pump (62), which introduces fluid into the interior volume (56) of the vessel (50) through at least one conduit (such as, conduit 71 of FIG. 2), and the pump (62) removes fluid from the interior volume (56) of the vessel (50) through at least one conduit (such as, conduit 71 of FIG. 2).

With some embodiments, inlet (65) of pump (62) is in fluid communication with a source of fluid, such as, a source of lotic water (not shown) through an inlet conduit (such as, inlet conduit 74 and first conduit 89 of FIG. 2), and outlet (68) of pump (62) is in fluid communication with the interior volume (56) of the vessel (50) through an outlet conduit. Fluid drawn through the inlet conduit passes through the inlet (65), through pump (62), through the outlet (68), through the outlet conduit and into the interior volume or space (56) of the vessel (50). With some embodiments, and for purposes of removing fluid from the vessel (50), the inlet conduit is placed in fluid communication with the interior volume (56) of the vessel (50), the outlet conduit is placed in fluid communication with, for example, a point of use, such as a hydrofracturing well, the pump (62) is activated, and fluid (80) is drawn out of vessel (50), through the inlet conduit, through the inlet (65), through pump (62), through the outlet (68), through the outlet conduit, and to the point of use (such as, a hydrofracturing well).

With some embodiments, and with reference to FIG. 2, pump assembly (59a) includes a conduit circuit (83), which includes an inlet conduit (74) that includes inline an inlet valve (86). Inlet conduit (74) is in fluid communication with a first conduit (89) at an inlet junction (90), which is in fluid communication with the inlet (65) of pump (62). Outlet (68) of pump (62) is in fluid communication with a second conduit (92). Second conduit (92) is in fluid communication with outlet conduit (77) at an outlet junction (95). Second conduit (92) includes inline a first valve (98). Second conduit (92) is in fluid communication with conduit (71) and first conduit (89) at a T-junction (101). Conduit (71) is in fluid communication with fluid (80) within interior volume (56) of vessel (50).

Outlet conduit (77) includes inline an outlet valve (104). First conduit (89) includes inline a second valve (107). Inlet valve (86) is positioned inline in inlet conduit (74) and prior to (or upstream from) inlet junction (90). Outlet valve (104) is positioned inline in outlet conduit (77) and after (or downstream from) outlet junction (95). First valve (98) is positioned inline in second conduit (92) and between outlet junction (95) and T-junction (101). Second valve (107) is positioned inline in first conduit (89) and between T-junction (101) and inlet junction (90).

With some embodiments, and with reference to FIG. 2, first valve (98) is closed, second valve (107) is opened, inlet valve (86) is closed, outlet valve (104) is opened, pump (62) is activated, and fluid (80) is drawn from interior volume (56) of vessel (50), through conduit (71), T-junction (101), first conduit (89), second valve (107), inlet (65), pump (62), outlet (68), outlet junction (95), outlet conduit (77), and outlet valve (104), and forwarded to a point of use or other storage (not shown).

With further reference to FIG. 2, and in accordance with some embodiments, first valve (98) is opened, second valve (107) is closed, inlet valve (86) is opened, outlet valve (104) is closed, pump (62) is activated, and fluid is drawn through inlet conduit (74) from a source of fluid (not shown) through inlet valve (86), through inlet junction (90), through first conduit (89), through inlet (65), through pump (62), through outlet (68), through second conduit (92), through first valve (98), through T-junction (101), through conduit (71), through opening (53), and into interior volume (56) of vessel (50).

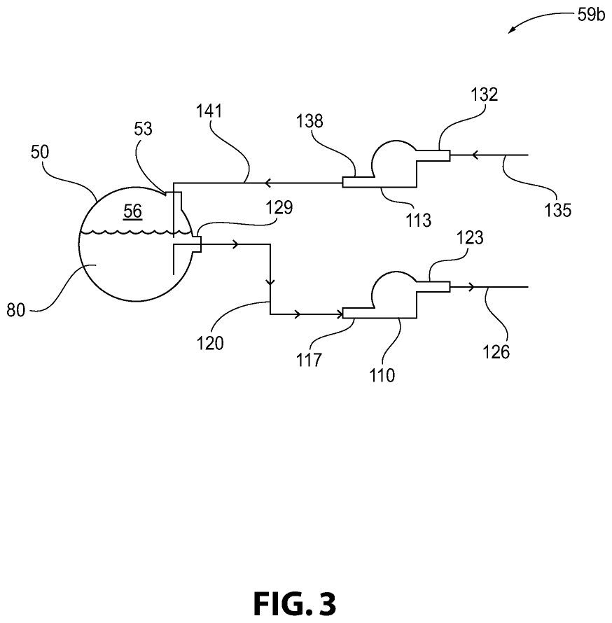

With some embodiments, and with reference to FIG. 3, the pump assembly (59b) includes two pumps, an outlet pump (110) and an inlet pump (113). Inlet pump (110) includes an inlet (117) that is in fluid communication with a first conduit (120), and an outlet (123) that is in fluid communication with a second conduit (126). First conduit (120) is in fluid communication with fluid (80) within interior volume (56) of vessel (50) through an aperture (129). Inlet pump (113) includes an inlet (132) that is in fluid communication with a third conduit (135), and an outlet (138) that is in fluid communication with a fourth conduit (141), which is in fluid communication with interior volume (56) of vessel (50) through opening (53).

With some embodiments, inlet pump (113) is activated, while outlet pump (110) is inactivated, and fluid is drawn from a source (not shown) through third conduit (135), through inlet (132), through inlet pump (113), through outlet (138), through fourth conduit (141) and into interior volume (56) of vessel (50).

With some further embodiments, outlet pump (110) is activated, while inlet pump (113) is inactivated, and fluid (80) is drawn from interior volume (56) of vessel (50) through first conduit (120) extending through aperture (129), through inlet (117), through outlet pump (110), through outlet (123), and through second conduit (126) to a downstream point of further use and/or storage (not shown).

The vessel of the present invention can be fabricated from any suitable material or combination of materials, such as, but not limited to, metals, ceramics, organic polymers (including thermoplastic and/or crosslinked organic polymers), and/or inorganic polymers. The vessel, with some embodiments, is fabricated from a material that includes plastic, such as, one or more thermoplastics, one or more crosslinked plastics, and combinations thereof.

The vessel (50), with some embodiments, is a substantially cylindrical vessel (50) having a longitudinal axis (144), the open-box bed (14), of the self-propelled vehicle (11), has a longitudinal axis (147), and the longitudinal axis (144) of the vessel (50) and the longitudinal axis (147) of the open-box bed (14) are substantially parallel to each other.

The vessel can have a wide range of interior volumes. With some embodiments, the interior volume of the vessel is from 500 gallons to 10,000 gallons (1893 liters to 37,854 liters), such as from 800 gallons to 5000 gallons (3028 liters to 18,927 liters).

The fluid within the vessel is, with some embodiments, a liquid at ambient pressure. The fluid, with some embodiments, includes water. With some further embodiments, the fluid in the vessel is selected from city water, well water, lotic water, hydrofracture flowback water, hydrofracture production water, and combinations thereof.

The self-propelled vessel assembly of the present invention can be used in conjunction with a number of applications. Such applications include, but are not limited to, drawing, providing, and/or transferring fluids associated with, hydraulic fracturing, farming, ranching, and fire-fighting.

The present invention can be further characterized by one or more of the following non-limiting clauses.

Clause 1: A self-propelled vessel assembly comprising:

(a) a self-propelled vehicle comprising,
an open-box bed comprising a first sidewall, a second side-wall, a forward wall, an optional tailgate, and a floor, that together define a box volume, wherein said first sidewall and said second sidewall are opposed to each other, and said optional tailgate and said forward wall are opposed to each other; and

(b) a vessel that is reversibly received within said box volume, said vessel having an interior volume; and
(c) a pump assembly comprising at least one pump positioned on a support structure that is reversibly attached to said self-propelled vehicle, said pump assembly comprising at least one conduit that is in fluid communication with said pump and said interior volume of said vessel.

Clause 2: The self-propelled vessel assembly of clause 1, wherein said self-propelled vehicle is a dump truck.

Clause 3: The self-propelled vessel assembly of claim 2, wherein said dump truck is a triaxle dump truck.

Clause 4: The self-propelled vessel assembly of any one of clauses 1 to 3, wherein said pump introduces fluid into said interior volume of said vessel through said at least one conduit, and said pump removes fluid from said interior volume of said vessel through said at least one conduit.

Clause 5: The self-propelled vessel assembly of any one of clauses 1 to 4, wherein said pump assembly comprises,

a first pump that comprises a first conduit that is in fluid communication with said first pump and said interior volume of said vessel, and

a second pump that comprises a second conduit that is in fluid communication with said interior volume of said vessel,
wherein said first pump introduces fluid into said interior volume of said vessel, and said second pump removes fluid from said interior volume of said vessel.

Clause 6: The self-propelled vessel assembly of any one of clauses 1 to 5, wherein said vessel is fabricated from a material comprising plastic.

Clause 7: The self-propelled vessel assembly of any one of clauses 1 to 6, wherein said vessel is a substantially cylindrical vessel having a longitudinal axis, said open-box bed has a longitudinal axis, and said longitudinal axis of said vessel and said longitudinal axis of said open-box bed are substantially parallel to each other.

The present invention has been described with reference to specific details of particular embodiments thereof. It is not intended that such details be regarded as limitations upon the scope of the invention except insofar as to the extent that they are included in the accompanying claims.

What is claimed is:

1. A self-propelled vessel assembly comprising:
(a) a self-propelled vehicle comprising,
an open-box bed comprising a first sidewall, a second side-wall, a forward wall, an optional tailgate, and a floor, that together define a box volume, wherein said first sidewall and said second sidewall are opposed to each other, and said optional tailgate and said forward wall are opposed to each other; and
(b) a vessel that is reversibly received within said box volume, said vessel having an interior volume; and
(c) a pump assembly comprising at least one pump positioned on a support structure that is reversibly attached to said self-propelled vehicle, said pump assembly comprising at least one conduit that is in fluid communication with said pump and said interior volume of said vessel.

2. The self-propelled vessel assembly of claim 1, wherein said self-propelled vehicle is a dump truck.

3. The self-propelled vessel assembly of claim 2, wherein said dump truck is a triaxle dump truck.

4. The self-propelled vessel assembly of claim 1, wherein said pump introduces fluid into said interior volume of said vessel through said at least one conduit, and said pump removes fluid from said interior volume of said vessel through said at least one conduit.

5. The self-propelled vessel assembly of claim 1, wherein said pump assembly comprises,
a first pump that comprises a first conduit that is in fluid communication with said first pump and said interior volume of said vessel, and
a second pump that comprises a second conduit that is in fluid communication with said interior volume of said vessel,
wherein said first pump introduces fluid into said interior volume of said vessel, and said second pump removes fluid from said interior volume of said vessel.

6. The self-propelled vessel assembly of claim 1, wherein said vessel is fabricated from a material comprising plastic.

7. The self-propelled vessel assembly of claim 1, wherein said vessel is a substantially cylindrical vessel having a longitudinal axis, said open-box bed has a longitudinal axis, and said longitudinal axis of said vessel and said longitudinal axis of said open-box bed are substantially parallel to each other.
